(19) United States
(12) Patent Application Publication
(10) Pub. No.: US 2026/0101386 A1
(43) Pub. Date: Apr. 9, 2026

(54) DYNAMIC CHANGE OF GAP PRIORITY

(71) Applicant: Nokia Technologies Oy, Espoo (FI)

(72) Inventors: Faranaz SABOURI-SICHANI, Aalborg (DK); Laura Luque SANCHEZ, Aalborg (DK); Lars DALSGAARD, Oulu (FI); Srinivasan SELVAGANAPATHY, Bangalore (IN); Rafael CAUDURO DIAS DE PAIVA, Aalborg (DK)

(21) Appl. No.: 19/115,668

(22) PCT Filed: Sep. 12, 2023
(86) PCT No.: PCT/IB2023/059046

§ 371 Date: Mar. 26, 2025

(30) Foreign Application Priority Data
Sep. 29, 2022 (IN) 202241055935

(51) Int. Cl. H04W 74/08; H04W 24/08; H04W 76/20

(52) U.S. Cl. CPC H04W 74/0875; H04W 24/08; H04W 76/20

(57) ABSTRACT

A method may include receiving, from a first network, a configuration of a group priority of the first network and a group priority of a second network, a gap priority of gaps associated to the first network, and a condition under which a user equipment can modify the gap priority of gaps associated to the first network relative to a gap priority of gaps associated to the second network. The method may also include requesting the first network for gaps related to activities of a second network. The method may further include monitoring the condition received from the first network. In addition, the method may include modifying, in response to the monitoring, the gap priority of gaps associated to the first network element or the gap priority of gaps associated to the second network.

### RELATED APPLICATION

This application claims priority to IN Application No. 202241055935 filed Sep. 29, 2022, which is incorporated herein by reference in its entirety.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for dynamically changing gap priorities.

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, and/or fifth generation (5G) radio access technology or NR access technology. 5G wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include receiving, from a first network, a configuration of a group priority of the first network and a group priority of a second network, a gap priority of gaps associated to the first network, and a condition under which a user equipment can modify the gap priority of gaps associated to the first network relative to a gap priority of gaps associated to the second network. The method may also include requesting the first network for gaps related to activities of a second network. The method may further include monitoring the condition received from the first network. In addition, the method may include modifying, in response to the monitoring, the gap priority of gaps associated to the first network element or the gap priority of gaps associated to the second network.

Other example embodiments may be directed to an apparatus. The apparatus may include at least one processor and at least one memory including computer program code. The at least one memory and computer program code may also be configured to, with the at least one processor, cause the apparatus at least to receive, from a first network, a configuration of a group priority of the first network and a group priority of a second network, a gap priority of gaps associated to the first network, and a condition under which the apparatus can modify the gap priority of gaps associated to the first network relative to a gap priority of gaps associated to the second network. The apparatus may also be caused to request the first network for gaps related to activities of a second network. The apparatus may further be caused to monitor the condition received from the first network. In addition, the method may be caused to modify, in response to the monitoring, the gap priority of gaps associated to the first network element or the gap priority of gaps associated to the second network.

Other example embodiments may be directed to an apparatus. The apparatus may include means for receiving, from a first network, a configuration of a group priority of the first network and a group priority of a second network, a gap priority of gaps associated to the first network, and a condition under which the apparatus can modify the gap priority of gaps associated to the first network relative to a gap priority of gaps associated to the second network. The apparatus may also include means for requesting the first network for gaps related to activities of a second network. The apparatus may further include means for monitoring the condition received from the first network. In addition, the apparatus may include means for modifying, in response to the monitoring, the gap priority of gaps associated to the first network element or the gap priority of gaps associated to the second network.

In accordance with other example embodiments, a non-transitory computer readable medium may be encoded with instructions that may, when executed in hardware, perform a method. The method may include receiving, from a first network, a configuration of a group priority of the first network and a group priority of a second network, a gap priority of gaps associated to the first network, and a condition under which a user equipment can modify the gap priority of gaps associated to the first network relative to a gap priority of gaps associated to the second network. The method may also include requesting the first network for gaps related to activities of a second network. The method may further include monitoring the condition received from the first network. In addition, the method may include modifying, in response to the monitoring, the gap priority of gaps associated to the first network element or the gap priority of gaps associated to the second network.

Other example embodiments may be directed to a computer program product that performs a method. The method may include receiving, from a first network, a configuration of a group priority of the first network and a group priority of a second network, a gap priority of gaps associated to the first network, and a condition under which a user equipment can modify the gap priority of gaps associated to the first network relative to a gap priority of gaps associated to the second network. The method may also include requesting the first network for gaps related to activities of a second network. The method may further include monitoring the condition received from the first network. In addition, the method may include modifying, in response to the monitoring, the gap priority of gaps associated to the first network element or the gap priority of gaps associated to the second network.

Other example embodiments may be directed to an apparatus that may include circuitry configured to receive, from a first network, a configuration of a group priority of the first network and a group priority of a second network, a gap priority of gaps associated to the first network, and a condition under which the apparatus can modify the gap priority of gaps associated to the first network relative to a gap priority of gaps associated to the second network. The apparatus may also include circuitry configured to request the first network for gaps related to activities of a second network. The apparatus may further include circuitry configured to monitor the condition received from the first network. In addition, the apparatus may include circuitry configured to modify, in response to the monitoring, the gap priority of gaps associated to the first network element or the gap priority of gaps associated to the second network.

Certain example embodiments may be directed to a method. The method may include configuring, by a first network, a group priority related to activities of a user equipment that comprises a plurality of network subscriptions, a gap priority of gaps associated to the first network, a group priority of the first network, and a group priority of a second network. The method may also include configuring the user equipment with first network related gaps, the group priority, and a condition to modify the gap priority of gaps associated to the first network or a gap priority of gaps associated to the second network. The method may further include receiving a request from the user equipment for gaps related to activities of the second network. In addition, the method includes configuring the user equipment with gaps related to activities of the second network.

Other example embodiments may be directed to an apparatus. The apparatus may include at least one processor and at least one memory including computer program code. The at least one memory and computer program code may be configured to, with the at least one processor, cause the apparatus at least to configure a group priority related to activities of a user equipment that comprises a plurality of network subscriptions, a gap priority of gaps associated to the apparatus, a group priority of the apparatus, and a group priority of a network. The apparatus may also be caused to configure the user equipment with apparatus related gaps, the group priority, and a condition to modify the gap priority of gaps associated to the apparatus or a gap priority of gaps associated to the network. The apparatus may further be caused to receive a request from the user equipment for gaps related to activities of the network. In addition, the apparatus may be caused to configure the user equipment with gaps related to activities of the network.

Other example embodiments may be directed to an apparatus. The apparatus may include means for configuring a group priority related to activities of a user equipment that comprises a plurality of network subscriptions, a gap priority of gaps associated to the apparatus, a group priority of the apparatus, and a group priority of a network. The apparatus may also include means for configuring the user equipment with apparatus related gaps, the group priority, and a condition to modify the gap priority of gaps associated to the apparatus or a gap priority of gaps associated to the network. The apparatus may further include means for receiving, a request from the user equipment for gaps related to activities of the network. In addition, the apparatus may include means for configuring the user equipment with gaps related to activities of the network.

In accordance with other example embodiments, a non-transitory computer readable medium may be encoded with instructions that may, when executed in hardware, perform a method. The method may include configuring, by a first network, a group priority related to activities of a user equipment that comprises a plurality of network subscriptions, a gap priority of gaps associated to the first network, a group priority of the first network, and a group priority of a second network. The method may also include configuring the user equipment with first network related gaps, the group priority, and a condition to modify the gap priority of gaps associated to the first network or a gap priority of gaps associated to the second network. The method may further include receiving a request from the user equipment for gaps related to activities of the second network. In addition, the method includes configuring the user equipment with gaps related to activities of the second network.

Other example embodiments may be directed to a computer program product that performs a method. The method may include configuring, by a first network, a group priority related to activities of a user equipment that comprises a plurality of network subscriptions, a gap priority of gaps associated to the first network, a group priority of the first network, and a group priority of a second network. The method may also include configuring the user equipment with first network related gaps, the group priority, and a condition to modify the gap priority of gaps associated to the first network or a gap priority of gaps associated to the second network. The method may further include receiving a request from the user equipment for gaps related to activities of the second network. In addition, the method includes configuring the user equipment with gaps related to activities of the second network.

Other example embodiments may be directed to an apparatus that may include circuitry configured to configure a group priority related to activities of a user equipment that comprises a plurality of network subscriptions, a gap priority of gaps associated to the apparatus, a group priority of the apparatus, and a group priority of a network. The apparatus may also include circuitry configured to configure the user equipment with apparatus related gaps, the group priority, and a condition to modify the gap priority of gaps associated to the apparatus or a gap priority of gaps associated to the network. The apparatus may further include circuitry configured to receive a request from the user equipment for gaps related to activities of the network. In addition, the apparatus may include circuitry configured to configure the user equipment with gaps related to activities of the network.

### BRIEF DESCRIPTION OF THE DRAWINGS

For proper understanding of example embodiments, reference should be made to the accompanying drawings, wherein:

FIG. 1 illustrates an example signaling diagram, according to certain example embodiments.

FIG. 2 illustrates an example flow diagram of a method, according to certain example embodiments.

FIG. 3 illustrates an example flow diagram of another method, according to certain example embodiments.

FIG. 4 illustrates a set of apparatuses, according to certain example embodiments.

### DETAILED DESCRIPTION:

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for dynamically changing gap priorities. For instance, certain example embodiments may be directed to dynamically changing multiple universal subscriber identity module (MUSIM) gaps priorities.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, “network” or other similar language throughout this specification may be used interchangeably. Additionally, the term network A (NW-A) maybe used when referring to a network where a user equipment (UE) is in RRC_CONNECTED mode with its first universal subscriber identity module (USIM), and network B (NW-B) may be used when referring to the network where the UE is in RRC_IDLE mode or RRC_INACTIVE mode with its second USIM. Further, the term “gap” may refer to when the UE is not scheduled with downlink/uplink (DL/UL) activities related to its connection with a NW (e.g., NW-A) and, thus, may perform other activities during the gap.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As described in the technical specifications of 3^{rd} Generation Partnership Project (3GPP), there may be certain challenges to support MUSIM functionality where a UE may need to maintain independent communication with networks (NWs) corresponding to each of the UE's USIMs. In particular, 3GPP defines MUSIM gaps that allow a MUSIM UE to request a maximum of three periodic gaps, and one aperiodic gap from NW-A where the UE is in RRC_CONNECTED mode to run necessary procedures (e.g., paging monitoring and measurements) in NW-B, where the UE is in RRC_IDLE mode or RRC_INACTIVE mode. For this purpose, gap patterns for MUSIM have been introduced. However, corresponding radio resource management (RRM) requirements are not specified due to lack of 3GPP time allocations (TU) in related working group, i.e. RAN4.

A MUSIM device may have two or more simultaneous 3GPP/3GPP2 network subscriptions with multiple corresponding international mobile subscriber identities (IMSI) in case of an evolved packet system (EPS) or subscription permanent identifier (SUPI). In case of 5GS, each associated network subscription may belong to the same or different mobile network operator (MNO) or mobile virtual network operator (MVNO). In some cases, the maximum number of supported USIMs for a UE may be two. However, some UEs may support three USIMs.

There may be two types of MUSIM devices depending on the supported simultaneous RRC_states on the USIMs. In a first type, the MUSIM devices may be a dual SIM dual standby (DSDS) or multi USIM multi standby (MUMS) device which are registered with two or more independent subscriber IDs (USIMs), and can be in RRC_IDLE mode on all USIMs. However, such devices may only be on RRC_CONNECTED mode with a single USIM at a given time. In a second type, the MUSIM devices may be a dual SIM dual active or multi USIM multi active (MUMA) device, which are registered with two or more independent subscriber IDs (USIMs), and can be in RRC_IDLE mode on all USIMs. Additionally, the second type devices may maintain RRC_CONNECTED mode activities on all USIMs.

Furthermore, a UE's behavior with respect to the simultaneous handling of MUSIMs may depend on the UE's capabilities related to concurrent independent Rx and/or Tx operations. For instance, in singleRx/singleTx operations, the UE may only be capable of receiving traffic from one NW and/or transmitting traffic to one NW at a time (type 1). In dualRx/singleTx operations, the UE may be capable of simultaneously receiving traffic from two NWs, but may be capable of transmitting to only one NW at a time (type 2). Further, for dualRx/dualTx operations, the UE may be capable of simultaneously receiving and/or transmitting to/from two networks (type 3).

A dualRx UE may expected to perform simultaneous Rx activities on both the UE's USIMs (e.g., perform reception on the UE's USIM in RRC_IDLE/RRC_INACTIVE while maintaining RRC connection in another USIM, or perform independent RRC_IDLE/RRC_INACTIVE operations concurrently on more than one USIM). However, a dualRx MUSIM UE may still act as a singleRx UE for some specific band/frequency/bandwidth combinations due to, for example, a dependence on the radio frequency (RF) hardware (HW) design where not all Rx and Tx chains cover the full range of frequency range 1 (FR1) (i.e. frequency band groups low band (LB) covering frequencies below 1 GHz, mid band (MB) covering frequencies between 1 GHz and 2.2 GHz, high band (HB) covering frequencies between 2.3 GHz and 2.7 GHz, and ultra high band (UHB) covering frequencies between 3 GHz and 6 GHz), and frequency range 2 (FR2) covering m wave frequencies above 28 GHz, and support of multiple input multiple output (MIMO). It should be noted that the defined band groups in FR1 are not official 3GPP definitions but normally referred to by component vendors (e.g. filters, LNAs, PAs). Further, a dualRx MUSIM UE may act as a singleRx UE depending on the RF HW design front-end components which may be shared for carriers in the same band-group. Additionally, specific band combinations may not be possible due to in-device interference from the generated intermodulation.

3GPP specifications currently describe work on measurement gap enhancements, and priority-based rules to resolve problems related to concurrent gaps. These may include the possibility of assigning a priority to a gap and/or providing means for gap sharing in the IE MeasAndMobParameters to convey UE capabilities related to measurements for RRM, radio link monitoring (RLM), and mobility (e.g., handover). Currently, however, MUSIM gaps may be requested to NW-A for the UE's activities in NW-B where it is in RRC_IDLE mode or RRC_INACTIVE mode. Examples of such activities may include paging monitoring, RRM measurements for cell (re)selection, system information block (SIB) reading, RAN-based notification area update (RNAU)/tracking area update (TAU) messages, and transmitting BUSY indication. The UE may also receive gaps for NW-A measurements for the purpose of, for example, performing RRM on a serving cell and other measurements such as intra/inter-frequency and inter-RAT neighboring cell measurements, radio link monitoring (RLM), beam failure detection (BFD), or L1 measurements for beam management (BM). However, there is currently no requirement related to synchronization or alignment across the different NWs where each NW corresponds to different USIMs that may belong to the same or different vendor/PLMN. Thus, there is a possibility that the MUSIM gaps overlap with NW-A gaps.

Measurement gaps may be related to NW-A's own measurements as described above, and may be configured by NW-A while NW-B's activities are not known to NW-A. The defined priority procedure may be applied on NW-A's related gaps. However, there is a need to specify a mechanism to define priorities for NW-B's gaps. Assigning a static priority for MUSIM gaps cannot consider the actual use case. Additionally, the priorities for gaps related to NW-A or NW-B may be dynamically changed based on the UE's and NW's knowledge on when performing a measurement in NW-A or any activity in NW-B has higher importance (e.g., based on the observed radio link conditions). In view of the above challenges, certain example embodiments may therefore dynamically change the priority of MUSIM gaps (e.g., depending on the radio link condition observed by the UE in NW-A and/or NW-B).

As described above, certain example embodiments may dynamically change the priority of a measurement gap in NW-A and/or MUSIM gaps of NW-B for any RRC_IDLE/RRC_INACTIVE operation, and provide mechanisms to allow changing the priorities of the measurement gap in NW-A and/or MUSIM gaps of NW-B depending on given conditions. For instance, in certain example embodiments, the NW-A may already have assigned priorities to its configured measurement gaps, for example, for RRM measurements and possibly as well as L1 measurements (e.g., for beam management). In some example embodiments, the NW-A gaps may have also been collectively assigned a group priority.

In certain example embodiments, MUSIM gaps for NW-B operations may be assigned a group priority, which may be lower than NW-A's group priority. Besides the group priority, NW-A's gaps for different purpose may be configured with priority based on the purpose. As such, NW-A's gaps may be denoted as gap priorities for sake of understanding. In some example embodiments, the group priority and/or gap priorities may be (re)configured by NW-A via an RRCReconfiguration message. In other example embodiments, NW-A may determine and configure one or a set of conditions at which the UE can change the priority of NW-A's measurement gap. These conditions may include, for example, whether the UE has reached an RRM measurement reporting event. For example, the reporting event may be an event A2 where the UE's measured received signal from the serving cell has become worse than a configured threshold value. In another example embodiment, the reporting event may be an event A3 where the UE's measured received signal from a neighbor cell is better than the UE's measured received signal from the serving cell with a configured offset value. In another example embodiment, the condition may be a combination of several events such as, for example, several measurement reporting events. In certain example embodiments, when the UE has reached an RRM measurement reporting event, the UE may raise the priority of the RRM measurement gaps of NW-A.

According to certain example embodiments, another condition may include whether the UE has detected or predicted a radio link failure (RLF). For instance, in certain example embodiments, when the UE has detected or predicted an RLF condition, the UE may raise the priority of RLM measurement to be applied if UE's configured MUSIM gaps overlap with RLM-reference signal (RLM-RS) resource occasions (i.e., the UE may lower the priority of MUSIM gaps).

In certain example embodiments, another condition may include whether the UE has detected or predicted a beam failure (BF) condition. For instance, when the UE has detected or predicted a BF condition, the UE may raise the priority of the BFD measurement or new candidate search measurements to be applied if UE's configured MUSIM gaps overlap with a location of reference signals for beam failure detection and beam link recovery (i.e., the UE may lower the priority on MUSIM gaps).

In other example embodiments, another condition may include whether the UE has high mobility (i.e. it is moving with high speed, and/or its radio link condition is expected to change fast), and/or is in a cell edge (i.e., it is expected that the UE should be handed over to a neighboring cell in near future) or at the time of handover or measurement reporting, for example, for mobility. For instance, when the UE has high mobility and/or is in a cell edge, the UE may raise the priority of all measurement gaps. The UE's high mobility may increase the need for RRM measurements in NW-A as well as NW-B, and may raise the priority of corresponding gaps in both NW-A and NW-B. In further example embodiments, another condition may include whether the UE has observed a good serving cell condition in NW-A (e.g., whether UE is close to the cell center and has low mobility). For instance, when the UE has a good serving cell condition, the UE may lower the priority of all measurement activities in NW-A (e.g., RRM measurements as well as radio link and beam monitoring for NW-A, and prioritizing MUSIM gaps). In certain example embodiments, when the UE has received the conditions from NW-A, the UE may apply the conditions to determine when/if a priority may be changed without a further need for signaling.

According to certain example embodiments, NW-A may determine and configure the UE to indicate a UEAssistanceInformation (UAI) for priority change to a higher or a lower value for MUSIM gaps is allowed via an RRC reconfiguration message. Further, in certain example embodiments, upon receiving the RRC reconfiguration message by the UE, the UE may evaluate the conditions and use the UAI to inform NW-A about the changes in NW-A related gap priorities. According to certain example embodiments, the conditions may include, but not be limited to, for example, those described above and described in more detail below. For example, the conditions may include whether the UE has a high mobility and/or in a cell edge, and/or whether the UE has a low mobility and is close to the cell center. When the UE has a high mobility (i.e., UE is moving with high speed and expects its radio link condition to change fast), and/or is in the cell edge (i.e., it is expected that the UE should be handed over to a neighboring cell in the near future), the UE may raise the priority of MUSIM gaps for RRM measurements (predicted cell reselection). Further, when the UE has low mobility and is close to the cell center of NW-A, the UE may lower the priority of NW-A measurements. In certain example embodiments, the UE may raise the MUSIM gaps for certain activity in NW-B. In one example embodiment, this activity can be monitoring for paging in NW-B.

In certain example embodiments, when the priority of a MUSIM gap and a priority of a NW-A gap is the same when gap overlap occurs, the group priority may be applied. In some example embodiments, the configuration may also include information and rules such as whether the modification of the gap priority may be temporary or permanent. If the gap priority is temporary, the gap priority may revert to its previous priority after a certain amount of time has passed with no need for new signaling. In another example embodiment, the gap priority may revert to its previous priority after the condition for applying the priority change is no longer fulfilled. However, if the gap priority is permanent, new signaling may be needed.

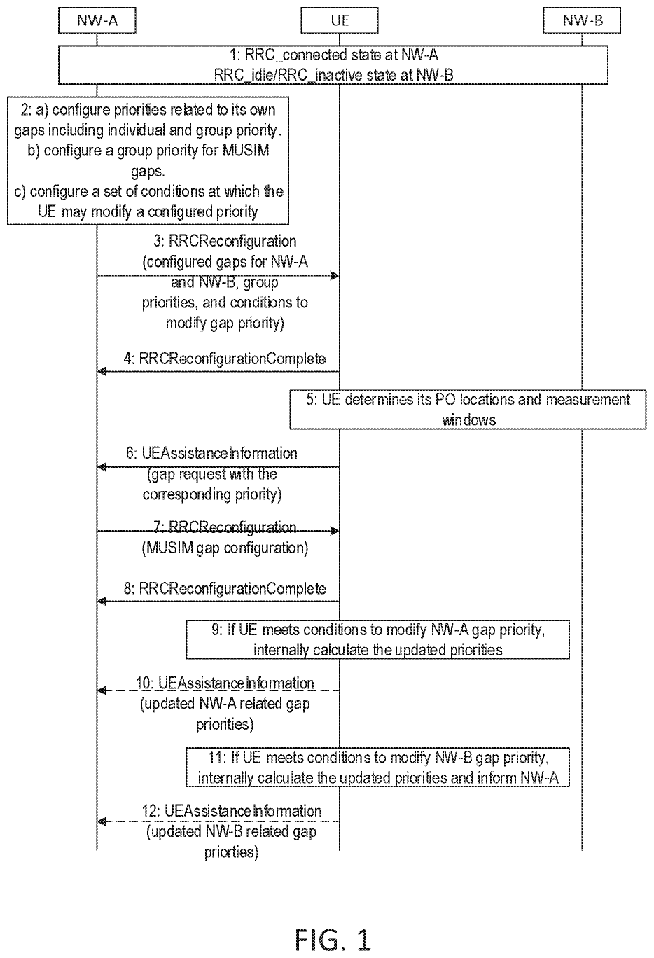

As described herein, certain example embodiments may include rules/methods to dynamically modify the gap priorities such that the UE may determine what to do if a MUSIM gap is colliding with a gap for NW-A measurements, or may cause interruption in RRC connection in a critical radio link and/or traffic scenario. As such, FIG. 1 illustrates an example signaling diagram, according to certain example embodiments.

At operation 1 of FIG. 1, a MUSIM UE may be in RRC_CONNECTED mode with NW-A, and in RRC_IDLE mode or RRC_INACTIVE mode with NW-B. At operation 2, NW-A may determine priorities for different activities. For instance, according to certain example embodiments, NW-A may configure the UE with its own gap priorities as well as a group priority for NW-A gaps. Additionally, NW-A may configure the UE with a group priority for MUSIM related activities (i.e., MUSIM gaps where the UE is performing activities related to NW-B), and may configure a set of conditions under which the UE may modify the gap priorities. Thus, in certain example embodiments, at operation 2, the configurations may be compiled at NW-A and later transmitted to the UE via an RRC message in operation 3, as described in more detail below. According to certain example embodiments, the priorities may refer to the relative group priority (i.e., raise or lower NW-A or NW-B group priority) or gap priority based on corresponding activity in NW-A or NW-B. According to certain example embodiments, the conditions may be any one or a combination of conditions described above.

In certain example embodiments, one condition may be related to the UE's mobility and predicted or already triggered mobility procedure (e.g., handover). In particular, the UE's predicted or already triggered mobility procedure may be predicted from a measurement report, such as, for example, measurement report on reporting event A2 or A3. In some example embodiments, different thresholds compared to thresholds to trigger measurement reports (e.g., A2 or A3) may be defined with values lower than the reporting threshold to predict deterioration in the absolute value of the received signal from the serving cell (which triggers measurement reporting based on A2 reporting event), or the reporting threshold of an appearance of strong neighboring cell earlier which may be reflected in the received signal from a neighboring cell being significantly higher than the received signal from the serving cell (which triggers measurement reporting based on A3 reporting event).

As previously noted, a condition may be a critical radio link condition where RLF is already declared or predicted to happen soon. In one example embodiment, different thresholds for RLF parameters Qin and/or Qout, or timers T310/T311 may be defined with values to predict and react to upcoming RLF condition(s). According to other example embodiments, another condition may be one that is expected to predict beam failure (i.e., depending on BFD measurement values). In certain example embodiments, different thresholds for BFD detection may be defined with values to predict and react on an upcoming beam failure condition.

In other example embodiments, the condition may include a timer associated with a change in MUSIM gap priority. For example, RLM out-of-sync indication may be used to reduce the priority of MUSIM gaps. This reduction may be active for a timer defined as time the UE has identified out-of-synchronization, TOOS, and after this time is expired, the MUSIM gap priorities may return to the previous configuration.

According to other example embodiments, the gNB may configure rules on how gap priorities are changed for each condition. For instance, an increase or decrease of priority may have a step equal to 1, or the maximum allowed priority within a group.

Returning to FIG. 1, at operation 3, NW-A may transmit the configuration to the UE with the NW-A related gaps, group priorities, and conditions defined in operation 2 to modify NW-A gap priorities using a radio resource control (RRC) message. At operation 4, the UE may indicate to NW-A that RRC Reconfiguration has been completed. At operation 5, the UE may determine, based on the information received in SIB from NW-B and UE-ID, the paging occasions (PO) locations and the measurement windows for RRM measurements.

As further illustrated in FIG. 1, at operation 6, the UE may request, using the RRC message and UAI, gaps from NW-A for activities related to NW-B. According to Rel-17, the UE may request up to 4 gaps (3 periodic gaps and 1 aperiodic gap). The UE may also include the corresponding gap priorities in the UAI. According to certain example embodiments, the gap priorities may be linked to the procedures (e.g., paging, RRM measurements, SIB reading, RNAU/RAU, BUSY indication), and may be predefined or configured by NW-A in operation 3.

At operation 7, NW-A may accept or reject the requested gaps by providing MUSIM gap configuration in RRC Reconfiguration. At operation 8, the UE may acknowledge that RRC Reconfiguration has been completed. Further, at operation 9, the UE may monitor the set of conditions provided (in operation 3) by NW-A for modifications of NW-A related gaps, and if any of the conditions are met. If the UE determines that one or more conditions are met, the UE may update the gap priority(-ies) accordingly. The set of conditions may include any of the conditions described above. According to certain example embodiments, if the priorities of two overlapping gaps are the same, the decision may be based upon the group priority. According to other example embodiments, the priorities may be specified for each gap operation independently, and the configuration may allow an increase or decrease in the priorities based on the defined condition. According to further example embodiments, the absolute priority (i.e., a condition will not make an increase or decrease in a priority, but may provide a single new priority value) corresponding to each condition may be configured.

As further illustrated in FIG. 1, at operation 10, the UE may optionally send UAI to inform NW-A about the updated priorities, or when a mobility event is triggered, the UE may use a measurement report to implicitly indicate a change in the MUSIM priority considering the rules defined in operation 2. Additionally, at operation 11, the UE may monitor the set of conditions provided in operation 3 by NW-A for modification of the priorities of NW-B related gaps. According to certain example embodiments, if any of the conditions is met, the UE may update the gap priority(-ies) accordingly. As previously noted, the conditions may include any one or a combination of conditions described above.

According to certain example embodiments, if the priorities of two overlapping gaps are the same, the group priority may be used to decide which gap/operation should be prioritized. According to other example embodiments, the priorities may be specified for each measurement operation independently, and the configuration may allow for the increase or decrease in the priorities based on the defined condition. According to further example embodiments, the absolute priority corresponding to each condition may be configured. In other example embodiments, the change in MUSIM gap priority may depend on the observed radio conditions in NW-A, and not necessarily be due to overlapping with the NW-A gap. At operation 12, the UE may optionally send UAI to inform NW-A about the updated priorities for MUSIM related gaps.

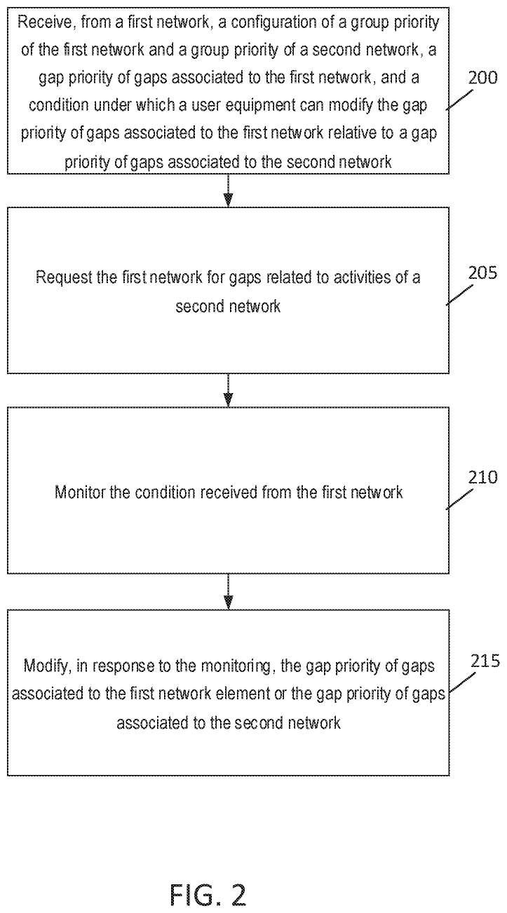

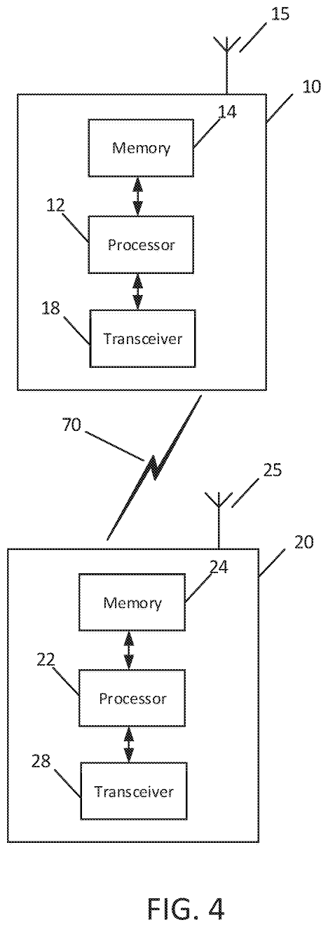

FIG. 2 illustrates an example flow diagram of a method, according to certain example embodiments. In an example embodiment, the method of FIG. 2 may be performed by a network entity, or a group of multiple network elements in a 3GPP system, such as LTE or 5G-NR. For instance, in an example embodiment, the method of FIG. 2 may be performed by a UE similar to one of apparatuses 10 or 20 illustrated in FIG. 4.

According to certain example embodiments, the method of FIG. 2 may include, at 200, receiving, from a first network, a configuration of a group priority of the first network and a group priority of a second network, a gap priority of gaps associated to the first network, and a condition under which a user equipment can modify the gap priority of gaps associated to the first network relative to a gap priority of gaps associated to the second network. The method may also include, at 205, requesting the first network for gaps related to activities of a second network. The method may further include, at 210, monitoring the condition received from the first network. In addition, the method may include, at 215, modifying, in response to the monitoring, the gap priority of gaps associated to the first network element or the gap priority of gaps associated to the second network.

According to certain example embodiments, the request may include the group priority and the gap priority of gaps associated to the second network. According to some example embodiments, the group priority of second network and the gap priority of gaps associated to the second network may be predefined or received by the configuration from the first network. According to other example embodiments, the condition may include at least one of whether the user equipment has reached or is close to reaching a radio resource management measurement reporting event, whether the user equipment has detected or predicted a radio link failure condition, whether the user equipment has detected or predicted a beam failure condition, whether the user equipment has high mobility or is in a cell edge, or whether the user equipment is close to a cell center and has low mobility.

In certain example embodiments, determination of operations on first network or the second network when the operations overlap in time may be based on the gap priority of gaps associated to the first network and the group priority of first network, and the gap priority of gaps associated to the second network and the group priority of second network. In some example embodiments, when the gap priority of gaps associated to the first network and the gap priority of gaps associated to the second network have equal value, the group priority of the first network and the group priority of second network may be applied. In other example embodiments, modifying the gap priority of gaps associated to the first network or the group priority may include increasing or decreasing the gap priority of gaps associated to the first network or the group priority of the first network based on the condition.

According to certain example embodiments, the configuration may include information and rules on how the modification of the gap priority of gaps associated to the first network or the gap priority of gaps associated to the second network should be implemented. According to some example embodiments, the configuration may include information and rules of whether modification of the gap priority of gaps associated to the first network will be temporary or permanent. According to some example embodiments, the method may also include transmitting a first message containing user equipment assistance information to the first network. According to further example embodiments, the first message containing user equipment assistance information may include information about an update of the group priority or the gap priority of gaps associated to the first network. In some example embodiments, the method may also include transmitting a second message containing user equipment assistance information to the first network. In other example embodiments, the second message containing user equipment assistance information may include information about an update of the gap priority of gaps associated to the second network.

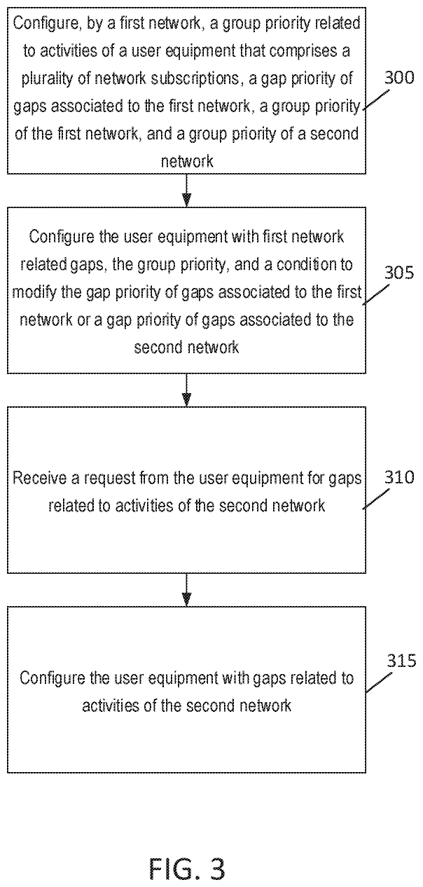

FIG. 3 illustrates an example of a flow diagram of another method, according to certain example embodiments. In an example embodiment, the method of FIG. 3 may be performed by a network entity, or a group of multiple network elements in a 3GPP system, such as LTE or 5G-NR. For instance, in an example embodiment, the method of FIG. 3 may be performed by a network, cell, gNB, or any other device similar to one of apparatuses 10 or 20 illustrated in FIG. 4.

According to certain example embodiments, the method of FIG. 3 may include, at 300, configuring, by a first network, a group priority related to activities of a user equipment that comprises a plurality of network subscriptions, a gap priority of gaps associated to the first network, a group priority of the first network, and a group priority of a second network. The method may also include, at 305, configuring the user equipment with first network related gaps, the group priority, and a condition to modify the gap priority of gaps associated to the first network or a gap priority of gaps associated to the second network. The method may further include, at 310, receiving a request from the user equipment for gaps related to activities of the second network. In addition, the method may include, at 315, configuring the user equipment with gaps related to activities of the second network.

According to certain example embodiments, the request may include a group priority and the gap priority of gaps associated to the second network. According to some example embodiments, the condition comprises at least one of whether the user equipment has reached or is close to reaching a radio resource management measurement reporting event, whether the user equipment has detected or predicted a radio link failure condition, whether the user equipment has detected or predicted a beam failure condition, whether the user equipment has high mobility or is in a cell edge, or whether the user equipment is close to a cell center and has low mobility. According to other example embodiments, the method may also include configuring rules on how the gap priority of gaps associated to the first network or the gap priority of gaps associated to the second network is changed for each condition.

In certain example embodiments, the method may further include receiving, at the first network, a first message containing user equipment assistance information from the user equipment comprising information about an update of the group priority or the gap priority of gaps associated to the first network, or the group priority or the gap priority of gaps associated to the second network. In some example embodiments, the method may also include receiving a second message containing user equipment assistance information from the user equipment comprising information about an update of the gap priority of gaps associated to the second network.

FIG. 4 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 4.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 10 may include components or features not shown in FIG. 4.

As illustrated in the example of FIG. 4, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 4, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-3.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-3.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a first network, a configuration of a group priority of the first network and a group priority of a second network, a gap priority of gaps associated to the first network, and a condition under which the apparatus can modify the gap priority of gaps associated to the first network relative to a gap priority of gaps associated to the second network. Apparatus 10 may also be controlled by memory 14 and processor 12 to request the first network for gaps related to activities of a second network. Apparatus 10 may further be controlled by memory 14 and processor 12 to monitor the condition received from the first network. In addition, Apparatus 10 may be controlled by memory 14 and processor 12 to modify, in response to the monitoring, the gap priority of gaps associated to the first network element or the gap priority of gaps associated to the second network.

As illustrated in the example of FIG. 4, apparatus 20 may be a network, core network element, or element in a communications network or associated with such a network, such as a gNB, or NW. It should be noted that one of ordinary skill in the art would understand that apparatus 20 may include components or features not shown in FIG. 4.

As illustrated in the example of FIG. 4, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 4, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1-3.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1-3.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 20 may be controlled by memory 24 and processor 22 to configure a group priority related to activities of a user equipment that includes a plurality of network subscriptions, a gap priority of gaps associated to the apparatus, a group priority of the apparatus, and a group priority of a network. Apparatus 20 may also be controlled by memory 24 and processor 22 to configure the user equipment with apparatus related gaps, the group priority, and a condition to modify the gap priority of gaps associated to the apparatus or a gap priority of gaps associated to the network. Apparatus 20 may further be controlled by memory 14 and processor 22 to receive a request from the user equipment for gaps related to activities of the network. In addition, apparatus 20 may be controlled by memory 14 and processor 22 to configure the user equipment with gaps related to activities of the network.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving, from a first network, a configuration of a group priority of the first network and a group priority of a second network, a gap priority of gaps associated to the first network, and a condition under which the apparatus can modify the gap priority of gaps associated to the first network relative to a gap priority of gaps associated to the second network. The apparatus may also include means for requesting the first network for gaps related to activities of a second network. The apparatus may further include means for monitoring the condition received from the first network. In addition, the apparatus may include means for modifying, in response to the monitoring, the gap priority of gaps associated to the first network element or the gap priority of gaps associated to the second network.

Certain example embodiments may also be directed to an apparatus that includes means for configuring a group priority related to activities of a user equipment that includes a plurality of network subscriptions, a gap priority of gaps associated to the apparatus, a group priority of the apparatus, and a group priority of a network. The apparatus may also include means for configuring the user equipment with apparatus related gaps, the group priority, and a condition to modify the gap priority of gaps associated to the apparatus or a gap priority of gaps associated to the network. The apparatus may further include means for receiving a request from the user equipment for gaps related to activities of the network. In addition, the apparatus may include means for configuring the user equipment with gaps related to activities of the network.

Certain example embodiments described herein provide several technical improvements, enhancements, and /r advantages. For instance, in some example embodiments, it may be possible to define means to handle the priority of MUSIM gaps when overlapping with NW-A's gaps, or when MUSIM gaps require interruption in NW-A while the radio link and/or traffic is critical. Certain example embodiments also provide a definition of priorities corresponding to each procedure as well as group to RRC configuration. Certain example embodiments may further add a set of conditions for dynamic change of the priorities and corresponding rules to define, for example, a step, limit, and time period and add to the RRC configuration. Other example embodiments may add means in UAI to add priority to a MUSIM gap request, and add means in UAI to inform about priority modification..

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
BFD Beam Failure Detection
BM Beam Management
BS Base Station
CSS Common Search Space
DCI Downlink Control Information
DL Downlink
DSDA Dual SIM Dual Standby
DSDS Dual SIM Dual Active
eNB Enhanced Node B
E-UTRAN Evolved UTRAN
FPS Frames Per Second
gNB 5G or Next Generation NodeB
IMSI International Mobile Subscriber Identities
InS In Synch
LTE Long Term Evolution
MG Measurement Gap
MNO Mobile Network Operator
MVNO Mobile Virtual Network Operator
MUSIM Multiple USIM
NR New Radio
NW Network
RLF Radio Link Failure
RLM Radio Link Monitoring
RNAU RAN-based Notification Area Update
RRC Radio Resource Control
OOS Out of Synch
PO Paging Occasion
RRM Radio Resource Management
SIB System Information Block
TAU Tracking Area Update
UAI UEAssistanceInformation
UE User Equipment
UL Uplink
USIM Universal Subscriber Identity Module

1-36. (canceled)

37. An apparatus, comprising:
at least one processor; and
at least one memory comprising computer program code,
the at least one memory and the computer program code configured, with the at least one processor to cause the apparatus at least to:
receive, from a first network, a configuration of a group priority of the first network and a group priority of a second network, a gap priority of gaps associated to the first network, and a condition under which the apparatus can modify the gap priority of gaps associated to the first network relative to a gap priority of gaps associated to the second network;
request the first network for gaps related to activities of a second network;
monitor the condition received from the first network; and
modify, in response to the monitoring, the gap priority of gaps associated to the first network element or the gap priority of gaps associated to the second network.

38. The apparatus according to claim 37, wherein the request comprises the group priority and the gap priority of gaps associated to the second network.

39. The apparatus according to claim 37, wherein the group priority of second network and the gap priority of gaps associated to the second network are predefined or received by the configuration from the first network.

40. The apparatus according to claim 37, wherein the condition comprises at least one of the following:
whether the apparatus has reached or is close to reaching a radio resource management measurement reporting event,
whether the apparatus has detected or predicted a radio link failure condition,
whether the apparatus has detected or predicted a beam failure condition,
whether the apparatus has high mobility or is in a cell edge, or
whether the apparatus is close to a cell center and has low mobility.

41. The apparatus according to claim 37, wherein determination of operations on first network or the second network when the operations overlap in time is based on the gap priority of gaps associated to the first network and the group priority of first network, and the gap priority of gaps associated to the second network and the group priority of second network.

42. The apparatus according to claim 37, wherein when the gap priority of gaps associated to the first network and the gap priority of gaps associated to the second network have equal value, the group priority of the first network and the group priority of second network is applied.

43. The apparatus according to claim 37, wherein modifying the gap priority of gaps associated to the first network or the group priority comprises increasing or decreasing the gap priority of gaps associated to the first network or the group priority of the first network based on the condition.

44. The apparatus according to claim 37, wherein the configuration comprises information and rules on how the modification of the gap priority of gaps associated to the first network or the gap priority of gaps associated to the second network should be implemented.

45. The apparatus according to claim 37, wherein the configuration comprises information and rules of whether modification of the gap priority of gaps associated to the first network will be temporary or permanent.

46. The apparatus according to claim 37, wherein the at least one memory and the computer program code are further configured, with the at least one processor to cause the apparatus at least to:
transmit a first message containing user equipment assistance information to the first network,
wherein the first message containing user equipment assistance information comprises information about an update of the group priority or the gap priority of gaps associated to the first network.

47. The apparatus according to claim 37, wherein the at least one memory and the computer program code are further configured, with the at least one processor to cause the apparatus at least to:
transmit a second message containing user equipment assistance information to the first network,
wherein the second message containing user equipment assistance information comprises information about an update of the gap priority of gaps associated to the second network.

48. An apparatus, comprising:
at least one processor; and
at least one memory comprising computer program code,
the at least one memory and the computer program code configured, with the at least one processor to cause the apparatus at least to:
configure a group priority related to activities of a user equipment that comprises a plurality of network subscriptions, a gap priority of gaps associated to the apparatus, a group priority of the apparatus, and a group priority of a network;
configure the user equipment with apparatus related gaps, the group priority, and a condition to modify the gap priority of gaps associated to the apparatus or a gap priority of gaps associated to the network;
receive a request from the user equipment for gaps related to activities of the network; and configure the user equipment with gaps related to activities of the network.

49. The apparatus according to claim 48, wherein the request comprises a group priority and the gap priority of gaps associated to the network.

50. The apparatus according to claim 48, wherein the condition comprises at least one of the following:
whether the user equipment has reached or is close to reaching a radio resource management measurement reporting event,
whether the user equipment has detected or predicted a radio link failure condition,
whether the user equipment has detected or predicted a beam failure condition,
whether the user equipment has high mobility or is in a cell edge, or
whether the user equipment is close to a cell center and has low mobility.

51. The apparatus according to claim 48, wherein the at least one memory and the computer program code are further configured, with the at least one processor to cause the apparatus at least to:
configure rules on how the gap priority of gaps associated to the apparatus or the gap priority of gaps associated to the network is changed for each condition.

52. The apparatus according to claim 48, wherein the at least one memory and the computer program code are further configured, with the at least one processor to cause the apparatus at least to:
receive a first message containing user equipment assistance information from the user equipment comprising information about an update of the group priority or the gap priority of gaps associated to the apparatus, or the group priority or the gap priority of gaps associated to the network.

53. The apparatus according to claim 48, wherein the at least one memory and the computer program code are further configured, with the at least one processor to cause the apparatus at least to:
receive a second message containing user equipment assistance information from the user equipment comprising information about an update of the gap priority of gaps associated to the network.

54. A method comprising:
receiving, from a first network, a configuration of a group priority of the first network and a group priority of a second network, a gap priority of gaps associated to the first network, and a condition under which a user equipment can modify the gap priority of gaps associated to the first network relative to a gap priority of gaps associated to the second network;
requesting the first network for gaps related to activities of the second network;
monitoring the condition received from the first network; and
modifying, in response to the monitoring, the gap priority of gaps associated to the first network element or the gap priority of gaps associated to the second network.

55. The method according to claim 54, wherein the request comprises the group priority and the gap priority of gaps associated to the second network.

56. The method according to claim 54, wherein the group priority of second network and the gap priority of gaps associated to the second network are predefined or received by the configuration from the first network.
